(19) United States
(12) Patent Application Publication
(10) Pub. No.: US 2007/0035275 A1
(43) Pub. Date: Feb. 15, 2007

(54) Backup battery assembly for electronic device

(75) Inventors: Yung-Chi Yang, Taipei (TW); Shi-Xiang Yang, Taipei (TW)

Correspondence Address: EDWARDS & ANGELL, LLP, P.O. BOX 55874, BOSTON, MA, 02205, US

(73) Assignee: Inventec Corporation, Taipei (TW)

(21) Appl. No.: 11/337,037

(22) Filed: Jan. 19, 2006

(30) Foreign Application Priority Data
Aug. 10, 2005 (TW) 094213630

(51) Int. Cl. H02J 7/00

(52) U.S. Cl. 320/112

(57) ABSTRACT

A backup battery assembly for being assembled to a surface of an electronic device is provided. The backup battery assembly includes a battery body having a first surface and a second surface; a positioning fastener mounted on the first surface of the battery body; a movable fastener mounted on the first surface of the battery body; and an adjusting member mounted on the second surface of the battery body, for adjusting a distance between the positioning fastener and the movable fastener, so as to fasten or unfasten the backup battery assembly to or from the electronic device.

### FIELD OF THE INVENTION

The present invention relates to battery assemblies, and more particularly, to a backup battery assembly for an electronic device.

### BACKGROUND OF THE INVENTION

In order to improve operational convenience for users, portable electronic devices such as notebook computers have been developed.

A common problem encountered by various portable electronic devices is how to provide sufficient supply of power for the electronic devices to process more data or perform more calculations. A general solution includes providing a portable backup battery apart from developing a power saving design of the electronic device. For example of a notebook computer, besides an embedded rechargeable battery, the user may further prepare a long life backup battery for long time outdoor usage. The related prior arts include Taiwanese Utility Model Patent Application Nos. 89202823 and 92216240, as described hereinafter.

FIG. 1 shows a notebook computer 1 disclosed in Taiwanese Patent Application No. 89202823. A movable frame 11 is provided on a bottom surface of the notebook computer 1, and can be extended from the bottom surface of the notebook computer 1 to form a space for accommodating a backup battery 13.

However, the provision of the additional movable frame 11 for the notebook computer 1 to accommodate the backup battery 13 greatly changes the structural design of the notebook computer 1, which not only increases the manufacture cost but also increases the dimensions (length and width) of the notebook computer 1 when the movable frame 11 is extended for use, thereby not favorable for size miniaturization of the notebook computer 1. Moreover, when the movable frame 11 is being used for receiving the backup battery 13 therein, the components such as keyboard, touch pad and so on disposed on a top surface of the notebook computer 1 are elevated, such that a user needs to operate the notebook computer 1 with his/her wrists being suspended, thereby easy to cause injury to the user. Further, the backup battery 13 is merely fixed to the movable frame 11 by a simple connection between connectors (not shown) in the movable frame 11 and at a front end of the backup battery 13 without any other securing means, such that the backup battery 13 may easily be detached from the movable frame 11 when the notebook computer 1 is moved or relocated, and thus the power supply is interrupted.

FIG. 2 shows a notebook computer 2 disclosed in Taiwanese Patent Application No. 92216240. A movable connecting seat 21 is provided and received in a recessed groove on a side of the notebook computer 2, wherein an end of the connecting seat 21 is pivotally fixed to the notebook computer 2 and serves as a pivot for allowing the connecting seat 21 to move laterally out of the recessed groove such that a backup battery (not shown) can be coupled to the connecting seat 21.

However, the provision of the additional connecting seat 21, which requires preforming the recessed groove on the side of the notebook computer 2, leads to a great structural change of the notebook computer 2 and increase in the manufacture cost. Furthermore, the connecting seat 21 when in use would increase the overall dimensions of the notebook computer 2, thereby not favorable for size reduction. Moreover, as the backup battery is coupled to the connecting seat 21 only via corresponding connectors (not shown) thereof without any other securing means, such that the backup battery may easily be detached from the connecting seat 21 when the notebook computer 2 is moved or relocated, and thus the power supply is interrupted.

Therefore, the above conventional designs for incorporating a backup battery in a notebook computer make a great structural change of the notebook computer, which not only increase the complexity in structure, the manufacture cost and the size of the notebook computer, but also have a drawback that the backup battery may easily be detached from the notebook computer due to weak attachment therebetween.

Furthermore, if the keyboard and touch pad of the notebook computer can be made with a predetermined elevation angle relative to a plane where the notebook computer is situated, the user can comfortably operate the keyboard and touch pad according to the ergonomics principle. However, none of the current notebook computers provides such arrangement.

Accordingly, the problem to be solved here is to provide a backup battery assembly for an electronic device, which can overcome the foregoing drawbacks of the conventional designs and allow the electronic device to preferably provide a suitable operational elevation angle.

### SUMMARY OF THE INVENTION

In light of the foregoing drawbacks of the prior art, a primary objective of the present invention is to provide a backup battery assembly for an electronic device so as not to complicate the structural design of the electronic device.

Another objective of the present invention is to provide a backup battery assembly for an electronic device so as not to increase the size of the electronic device.

Still another objective of the present invention is to provide a backup battery assembly for an electronic device so as to improve attachment between the backup battery assembly and the electronic device.

A further objective of the present invention is to provide a backup battery assembly for an electronic device so as to allow the electronic device to provide an operational elevation angle.

In accordance with the above and other objectives, the present invention proposes a backup battery assembly for being mounted to a surface of an electronic device. The backup battery assembly comprises: a battery body at least having a first surface and an opposed second surface; at least one positioning fastener mounted on the first surface of the battery body; at least one movable fastener movably mounted on the first surface of the battery body at a first position where the movable fastener is spaced apart from the positioning fastener by a first distance; and an adjusting member mounted on the second surface of the battery body and connected to the movable fastener, for moving the movable fastener to a second position where the movable fastener is spaced apart from the positioning fastener by a second distance.

The first surface and the second surface of the battery body may intersect, or the first surface is slanted with respect to the second surface of the battery body. The movable fastener is mounted on a lower portion of the first surface of the battery body, and the positioning fastener is mounted on an upper portion of the first surface of the battery body.

The positioning fastener comprises an outwardly extended hook portion, and the movable fastener comprises an outwardly extended hook portion facing a direction opposite to that of the hook portion of the positioning fastener, such that the first distance is longer than the second distance. Alternatively, the positioning fastener comprises an inwardly extended hook portion, and the movable fastener comprises an inwardly extended hook portion facing a direction opposite to that of the hook portion of the positioning fastener, such that the first distance is shorter than the second distance.

The backup battery assembly of the present invention further comprises an elastic member for providing elastic force for keeping the movable fastener spaced apart from the positioning fastener by the first distance. Preferably, the elastic member is mounted inside the battery body and near the movable fastener or the adjusting member. The elastic member can be a spring or a leaf spring.

The backup battery assembly of the present invention further comprises a locking member mounted on the second surface of the battery body, for keeping the movable fastener spaced apart from the positioning fastener by the first distance. Preferably, the locking member is a switch capable of being switched to a releasing position where the movable fastener can be moved to the second position by the adjusting member, or capable of being switched to a locking position to lock the adjusting member or the movable fastener. The backup battery assembly further comprises an electric connector mounted on the first surface of the battery body. Preferably, the electric connector is a male connector.

The surface of the electronic device where the backup battery assembly can be mounted is at least formed with an electric contact, at least one first fastening portion and at least one second fastening portion. When the backup battery assembly is assembled to the electronic device, the electric connector is connected to the electric contact, the positioning fastener is fastened to the first fastening portion, and the movable fastener is fastened to the second fastening portion.

The electronic device can be a notebook computer, and the backup battery assembly is preferably assembled to a bottom surface of the notebook computer.

The backup battery assembly of the present invention allows the distance between the positioning fastener and the movable fastener to be adjusted by means of the adjusting member, so as to fasten or unfasten the back battery assembly to or from the electronic device and provide stable attachment between the backup battery assembly and the electronic device. For coupling to the positioning fastener and the movable fastener of the backup battery assembly, the electronic device is only necessarily formed with the fastening portions (such as fastening grooves) on the bottom surface thereof, without complicating the structural design of the electronic device. Further, the fastening portions or grooves are directly formed on the bottom surface of the electronic device without increasing the size of the electronic device, unlike the prior art using the movable frame or the connecting seat to undesirably increase the dimensions of the notebook computer. Moreover, as the backup battery assembly of the present invention is mounted to the bottom surface of the electronic device such as a rear portion of the bottom surface, the rear portion of the electronic device can be slightly elevated, such that the components such as keyboard, touch pad and so on of the electronic device become slightly slanted to provide an elevation angle for a user to comfortably operate the electronic device.

### BRIEF DESCRIPTION OF THE DRAWINGS

The present invention can be more fully understood by reading the following detailed description of the preferred embodiments, with reference made to the accompanying drawings, wherein:

FIG. 1 (PRIOR ART) is a schematic diagram of a notebook computer disclosed in Taiwanese Patent Application No. 89202823;

FIG. 2 (PRIOR ART) is a schematic diagram of a notebook computer disclosed in Taiwanese Patent Application No. 92216240;

FIG. 3 is a front view of a backup battery assembly according to the present invention;

FIG. 4 is a rear view of the backup battery assembly according to the present invention;

FIG. 5 is a rear cross-section view of the backup battery assembly according to the present invention;

FIG. 6 is a schematic diagram of an electronic device mounted with the backup battery assembly according to the present invention; and

FIG. 7 is a schematic diagram of an operational status of the electronic device shown in FIG. 6.

### DETAILED DESCRIPTION OF THE PREFERRED EMBODIMENTS

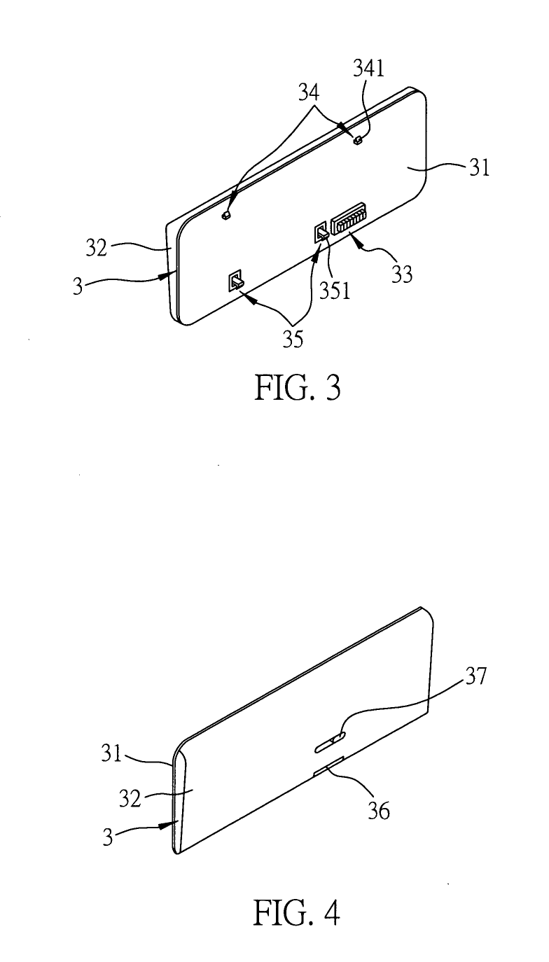

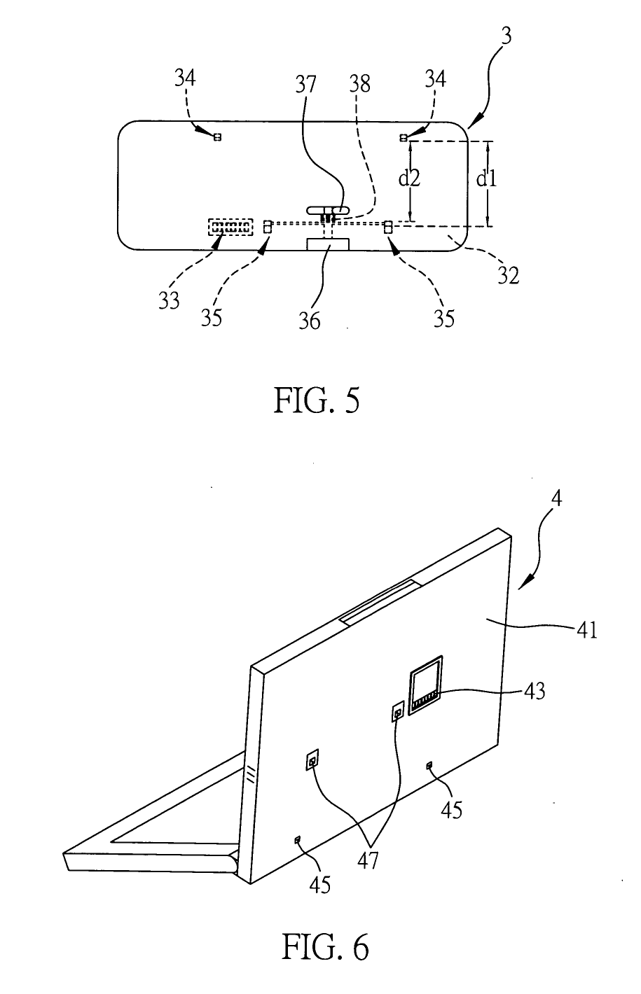

As shown in FIGS. 3, 4 and 5, the present invention proposes a backup battery assembly for an electronic device. The backup battery assembly comprises a battery body 3; and an electric connector 33, at least one positioning fastener 34, at least one movable fastener 35, an adjusting member 36 and a locking member 37 that are mounted on the battery body 3. The battery body 3 comprises a first surface 31 and an opposed second surface 32, wherein the first surface 31 is slanted with respect to the second surface 32, making the battery body 3 substantially have a wedge shape. It should be noted that the arrangement is not limited to having the first surface 31 slanted with respect to the second surface 32 as in this embodiment, the first surface 31 and the second surface 32 of the battery body 3 may further intersect to similarly make the battery body 3 substantially wedge-shaped.

The positioning fastener 34 is mounted on the first surface 31 of the battery body 3. The movable fastener 35 is movably mounted on the first surface 31 of the battery body 3 at a first position where the movable fastener 35 is spaced apart from the positioning fastener 34 by a first distance d1. The movable fastener 35 is located on a lower portion of the first surface 31 of the battery body 3, and the positioning fastener 34 is located of an upper portion of the first surface 31 of the battery body 3. The positioning fastener 34 comprises an outwardly extended hook portion 341, and the movable fastener comprises an outwardly extended hook portion 351 facing a direction opposite to that of the hook portion 341 of the positioning fastener 34. When the movable fastener 35 is moved toward the positioning fastener 34 to be located at a second position where the movable fastener 35 is spaced apart from the positioning fastener 34 by a second distance d2, the second distance d2 is shorter than the first distance d1, such that the distance between the movable fastener 35 and the positioning fastener 34 can be altered by adjusting the location of the movable fastener 35. In this embodiment, the outwardly extended hook portions 341, 351 can fasten the battery body 3 to the electronic device when the movable fastener 35 is spaced apart from the positioning fastener 34 by the first distance d1, or can unfasten the battery body 3 from the electronic device when the movable fastener 35 is spaced apart from the positioning fastener 34 by the second distance d2.

The electric connector 33 is mounted on the first surface 31 of the battery body 3 and can be located aside the movable fastener 35. In this embodiment, the electric connector 33 is a male electric connector, which is protruded from the first surface 31, and the electric connector 33 is electrically connected to the battery body 3.

The adjusting member 36 is mounted on the second surface 32 of the battery body 3 and is connected to the movable fastener 35. The adjusting member 36 can be pressed to adjust the location of the movable fastener 35, for example to move the movable fastener 35 to the second position where the movable fastener 35 is spaced apart from the positioning fastener 34 by the second distance d2. At least one elastic member 38, such as a spring or a leaf spring, is mounted inside the battery body 3 and near the adjusting member 36, to provide restoration elastic force for the pressed adjusting member 36 and the movable fastener 35. As the adjusting member 36 is connected to the movable fastener 35, after the adjusting member 36 is released from being pressed, the adjusting member 36 and the movable fastener 35 can be restored to their original positions via the restoration elastic force of the elastic member 38. That is, the movable fastener 35 is returned to the first position where the movable fastener 35 is spaced apart from the positioning fastener 34 by the first distance d1. The elastic member 38 may alternatively be located at a position near the movable fastener 35.

The locking member 37 is mounted on the second surface 32 of the battery body 3 and near the adjusting member 36. The locking member 37 can be used to keep the movable fastener 35 spaced apart from the positioning fastener 34 by the first distance d1. The locking member 37 is for example a binary switch, and can be switched to a releasing position or a locking position. When the locking member 37 is at the releasing position, the adjusting member 36 is free to be pressed. Alternatively, when the locking member 37 is at the locking position, the adjusting member 36 is locked and cannot be pressed, such that the movable fastener 35 is kept at the first position where the movable fastener 35 is spaced apart from the positioning fastener 34 by the first distance d1. As the adjusting member 36 is connected to the movable fastener 35, the locking member 37 may alternatively be set to lock the movable fastener 35 when the locking member 37 is switched to the locking position, such that the location of the movable fastener 35 is locked and cannot be adjusted by the adjusting member 36, that is, the movable fastener 35 is held in the first position where the movable fastener 35 is spaced apart from the positioning fastener 34 by the first distance d1.

As shown in FIG. 6, the backup battery assembly of the present invention can be mounted to a bottom surface 41 of an electronic device 4 such as a notebook computer. The bottom surface 41 of the electronic device 4 comprises an electric contact 43, at least one first fastening portion 45 and at least one second fastening portion 47, wherein the first and second fastening portions 45, 47 can be fastening grooves. The electric contact 43, the first fastening portion 45 and the second fastening portion 47 are located in a rear portion of the bottom surface 41 of the electronic device 4 and at positions corresponding to the electric connector 33, the positioning fastener 34 and the movable fastener 35 of the battery body 3 respectively.

When assembling the backup battery assembly of the present invention to the electronic device 4, firstly, the positioning fastener 34 is inserted into the first fastening portion 45 on the bottom surface 41 of the electronic device 4, and then, the movable fastener 35 is inserted into the second fastening portion 47. The electric connector 33 is connected to the electric contact 43 such that power can be provided from the battery body 3 to the electronic device 4. The restoration elastic force provided by the elastic member 38 keeps the movable fastener 35 staying at the first position where the movable fastener 35 is spaced apart from the positioning fastener 34 by the first distance d1, such that the backup battery assembly is stably assembled to the electronic device 4. On the other hand, the adjusting member 36 can be pressed to adjust the movable fastener 35 to the second position where the movable fastener 35 is spaced apart from the positioning fastener 34 by the shorter second distance d2, so as to unfasten the movable fastener 35 from the second fastening portion 47 and easily detach the backup battery assembly from the electronic device 4. Moreover, when the backup battery assembly is assembled to the electronic device 4, the locking member 37 can be switched to the locking position to keep the movable fastener 35 spaced apart from the positioning fastener 34 by the first distance d1, thereby further preventing detachment of the backup battery assembly from the electronic device 4 when the electronic device 4 is moved or relocated.

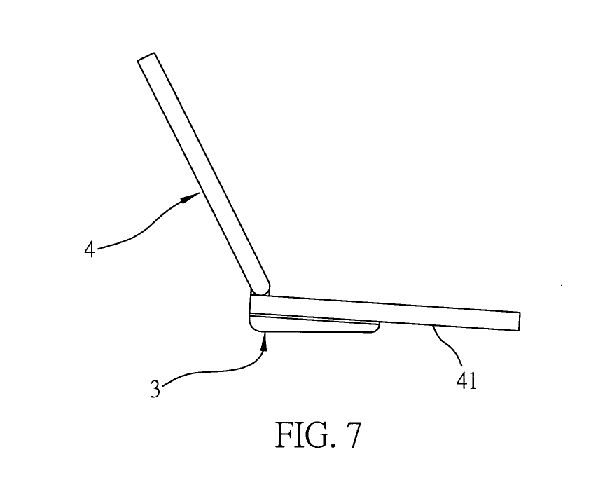

As shown in FIG. 7, when the backup battery assembly is assembled to the electronic device 4, as the battery body 3 is mounted to the rear portion of the bottom surface 41 of the electronic device 4 and is wedge-shaped, the rear portion of the electronic device 4 is slightly elevated to make the components such as a keyboard, a touch pad and so on of the electronic device 4 slightly slanted and provide an elevation angle for a user to comfortably operate the electronic device 4 according to the ergonomics principle.

In the above embodiment, each of the positioning fastener 34 and the movable fastener 35 comprises the outwardly extended hook portion 341, 351, such that by using the outwardly extended hook portions 341, 351 to fasten the positioning fastener 34 and the movable fastener 35 to the first fastening portion 45 and the second fastening portion 47 respectively, the first distance d1 for the fastening status is longer than the second distance d2 for the unfastening status. However, it should be understood that each of the positioning fastener 34 and the movable fastener 35 may alternatively comprises an inwardly extended hook portion. By using the inwardly extended hook portions to fasten the positioning fastener 34 and the movable fastener 35 to the first fastening portion 45 and the second fastening portion 47 respectively, the first distance d1 for the fastening status is shorter than the second distance d2 for the unfastening status. Other parts of the backup battery assembly can accordingly be altered in response to the structural modification of the hook portion. Consequently, the structural arrangement of the present invention is not limited to that described in the foregoing embodiment.

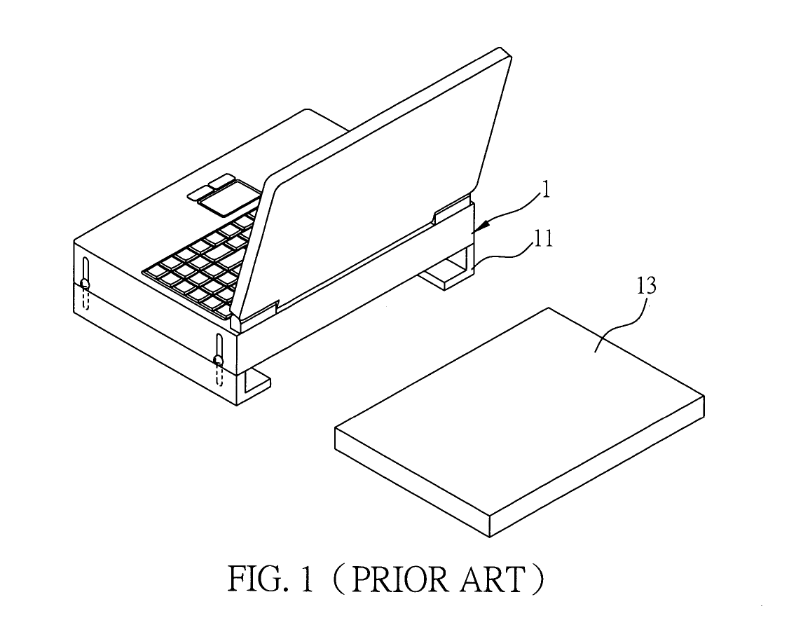

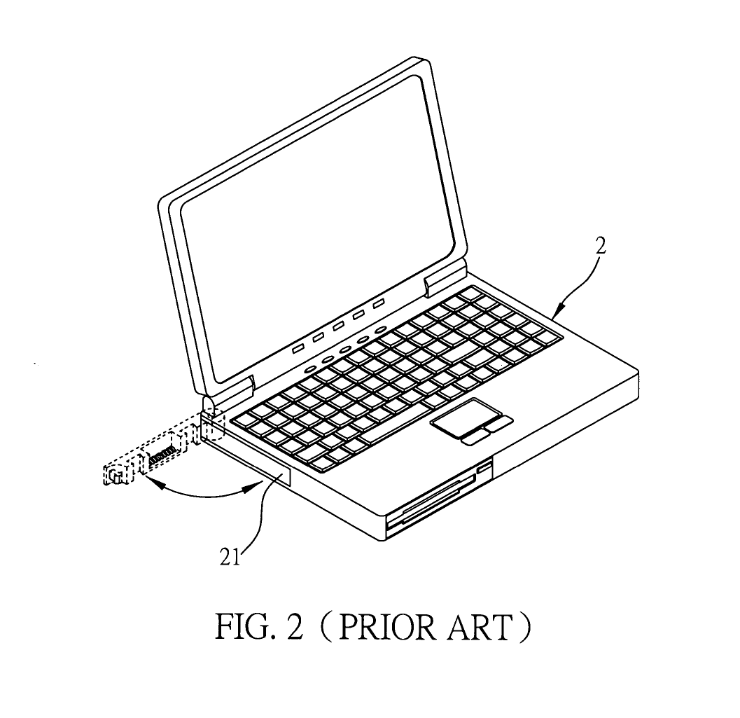

Therefore, the backup battery assembly of the present invention allows the distance between the positioning fastener and the movable fastener to be adjusted by means of the adjusting member, so as to fasten or unfasten the back battery assembly to or from the electronic device and provide stable attachment between the backup battery assembly and the electronic device. For coupling to the positioning fastener and the movable fastener of the backup battery assembly, the electronic device is only necessarily formed with the fastening portions (such as fastening grooves) on the bottom surface thereof, without complicating the structural design of the electronic device. Further, the fastening portions or grooves are directly formed on the bottom surface of the electronic device without increasing the size of the electronic device, unlike the prior art using the movable frame (FIG. 1) or the connecting seat (FIG. 2) to undesirably increase the dimensions of the notebook computer. Moreover, as the backup battery assembly of the present invention is mounted to the rear portion of the bottom surface of the electronic device, the rear portion of the electronic device can be slightly elevated, such that the components such as keyboard, touch pad and so on of the electronic device become slightly slanted to provide an elevation angle for the user to comfortably operate the electronic device according to the ergonomics principle. Consequently, the backup battery assembly of the present invention can overcome the drawbacks in the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A backup battery assembly for an electronic device, for being mounted to a surface of the electronic device, the backup battery assembly comprising:
a battery body comprising a first surface and an opposed second surface;
at least one positioning fastener mounted on the first surface of the battery body;
at least one movable fastener movably mounted on the first surface of the battery body at a first position where the movable fastener is spaced apart from the positioning fastener by a first distance; and
an adjusting member mounted on the second surface of the battery body and connected to the movable fastener, allowing the movable fastener to be moved by the adjusting member to a second position where the movable fastener is spaced apart from the positioning fastener by a second distance.

2. The backup battery assembly of claim 1, wherein the first surface is slanted with respect to the second surface of the battery body.

3. The backup battery assembly of claim 1, wherein the positioning fastener comprises an outwardly extended hook portion, and the movable fastener comprises an outwardly extended hook portion facing a direction opposite to that of the hook portion of the positioning fastener, and the first distance is longer than the second distance.

4. The backup battery assembly of claim 1, wherein the positioning fastener comprises an inwardly extended hook portion, and the movable fastener comprises an inwardly extended hook portion facing a direction opposite to that of the hook portion of the positioning fastener, and the second distance is longer than the first distance.

5. The backup battery assembly of claim 1, further comprising an elastic member mounted inside the battery body, for providing elastic force for keeping the movable fastener spaced apart from the positioning fastener by the first distance.

6. The backup battery assembly of claim 5, wherein the elastic member is one of a spring and a leaf spring.

7. The backup battery assembly of claim 1, further comprising a locking member mounted on the second surface of the battery body, for keeping the movable fastener spaced apart from the positioning fastener by the first distance.

8. The backup battery assembly of claim 7, wherein the locking member is a switch capable of being switched to a releasing position where the movable fastener can be moved to the second position by the adjusting member, or being switched to a locking position to lock the adjusting member.

9. The backup battery assembly of claim 7, wherein the locking member is a switch capable of being switched to a releasing position where the movable fastener can be moved to the second position by the adjusting member, or being switched to a locking position to lock the movable fastener.

10. The backup battery assembly of claim 1, further comprising an electric connector mounted on the first surface of the battery body.

11. A backup battery assembly for an electronic device, for being mounted to a surface of the electronic device, the surface of the electronic device at least having an electric contact, at least one first fastening portion, at least one second fastening portion, the backup battery assembly comprising:
a battery body comprising a first surface and an opposed second surface;
an electric connector mounted on the first surface of the battery body, for being connected to the electric contact;
at least one positioning fastener mounted on the first surface of the battery body, for being fastened to the first fastening portion;
at least one movable fastener movably mounted on the first surface of the battery body at a first position where the movable fastener is spaced apart from the positioning fastener by a first distance, the movable fastener for being fastened to the second fastening portion; and
an adjusting member mounted on the second surface of the battery body and connected to the movable fastener, allowing the movable fastener to be moved by the adjusting member to a second position where the movable fastener is spaced apart from the positioning fastener by a second distance.

12. The backup battery assembly of claim 11, wherein the first surface is slanted with respect to the second surface of the battery body.

13. The backup battery assembly of claim 11, wherein the positioning fastener comprises an outwardly extended hook portion, and the movable fastener comprises an outwardly extended hook portion facing a direction opposite to that of the hook portion of the positioning fastener, and the first distance is longer than the second distance.

14. The backup battery assembly of claim 11, wherein the positioning fastener comprises an inwardly extended hook portion, and the movable fastener comprises an inwardly extended hook portion facing a direction opposite to that of the hook portion of the positioning fastener, and the second distance is longer than the first distance.

15. The backup battery assembly of claim 11, further comprising an elastic member mounted inside the battery body, for providing elastic force for keeping the movable fastener spaced apart from the positioning fastener by the first distance.

16. The backup battery assembly of claim 15, wherein the elastic member is one of a spring and a leaf spring.

17. The backup battery assembly of claim 11, further comprising a locking member mounted on the second surface of the battery body, for keeping the movable fastener spaced apart from the positioning fastener by the first distance.

18. The backup battery assembly of claim 17, wherein the locking member is a switch capable of being switched to a releasing position where the movable fastener can be moved to the second position by the adjusting member, or being switched to a locking position to lock the adjusting member.

19. The backup battery assembly of claim 17, wherein the locking member is a switch capable of being switched to a releasing position where the movable fastener can be moved to the second position by the adjusting member, or being switched to a locking position to lock the movable fastener.

20. The backup battery assembly of claim 17, wherein the first fastening portion is a groove corresponding to the positioning fastener, and the second fastening portion is a groove corresponding to the movable fastener.
